(19) United States
(12) Patent Application Publication
(10) Pub. No.: US 2010/0017703 A1
(43) Pub. Date: Jan. 21, 2010

(54) METHOD AND SYSTEM FOR CREATING AND HOSTING A WEBSITE

(76) Inventors: Joe Glickman, JR., Whitefish, MT (US); Steven C. Glickman, Dallas, TX (US)

Correspondence Address: Michael A. O'Neil. P.C., 8150 North Central Expressway, Suite 1150, DALLAS, TX, 75206, US

(21) Appl. No.: 12/500,798

(22) Filed: Jul. 10, 2009

Related U.S. Application Data
(60) Provisional application No. 61/080,927, filed on Jul. 15, 2008.

(51) Int. Cl. G06F 17/00; G06F 15/177

(52) U.S. Cl. 715/234; 709/220

(57) ABSTRACT

A quick, easy, flexible, and efficient method and system for designing, creating, maintaining, editing, hosting and publicizing a website on the World Wide Web while concurrently providing additional benefits such as publication in a directory and creation of personalized accessories. The method and system for designing, creating, maintaining, editing and hosting a website with minimal input by a user, such input comprising a user name and email address, thereby affording a user efficiency, expediency, and ease in the setup, hosting and maintenance of the website.

### CROSS-REFERENCE TO RELATED APPLICATION

This application claims priority based on U.S. Provisional Patent Application No. 61/080,927 filed Jul. 15, 2008, the entire content of which is incorporated herein by reference.

### DESCRIPTION OF THE DRAWINGS

FIG. 1 is a schematic diagram of a method and system for creating and hosting a website comprising an embodiment of the present invention;

FIG. 2 is a flow chart illustrating a method and system for creating and hosting a website comprising another embodiment of the present invention; and

FIG. 3 is a flow chart illustrating a method and system for creating and hosting a website comprising yet another embodiment of the present invention.

### DETAILED DESCRIPTION

A website is a collection of web pages, images, videos, and/or other digital assets that is hosted on one or more computer servers, usually accessible via the internet. The World Wide Web constitutes all publicly accessible online websites and has exploded in popularity in recent years as an online presence has become commonplace for businesses, governments and individuals. As the World Wide Web has rapidly expanded, the number of websites located on the World Wide Web has grown almost exponentially.

Today stiff competition obliges most businesses to establish at least one website located on the World Wide Web to advertise, inform, and communicate with potential customers, current customers, third parties, or the public in general. Governments also have responded to the rapid growth of the internet. A plethora of local, state, and federal government entities have expanded operations online, establishing and maintaining websites accessible for public benefit. In addition individuals often create and publish websites online for their own personal or private use, including activities such as sharing photos, communicating with friends or family, or meeting new people. Non-profits such as churches and charities also establish and maintain an online presence via a website to inform members or the general public, solicit donations, and/or pursue the common good.

The number of websites online has grown rapidly as businesses, non-profits, governments, and individuals have become aware of the advantages of establishing an online presence. Consequently the demand for quick, easy, flexible, and efficient processes and systems for creating, maintaining, editing, hosting and publicizing websites on the World Wide Web has increased. By integrating several functions and systems that are usually performed separately, a website can be quickly and efficiently created, maintained, edited, hosted and publicized with minimum time, complexity or expertise required by the user.

An embodiment of the present invention provides a quick, easy, flexible, and efficient method and system for designing, creating, maintaining, editing, hosting and publicizing a website on the World Wide Web while concurrently providing additional benefits such as but not limited to publication in a directory and creation of personalized accessories. Another embodiment of the present invention provides a method and system for designing, creating, maintaining, editing and hosting a website on the World Wide Web with minimal input by a user, such input comprising without limitation a user name and email address, thereby affording a user efficiency, expediency, and ease in the setup, hosting and maintenance of the website.

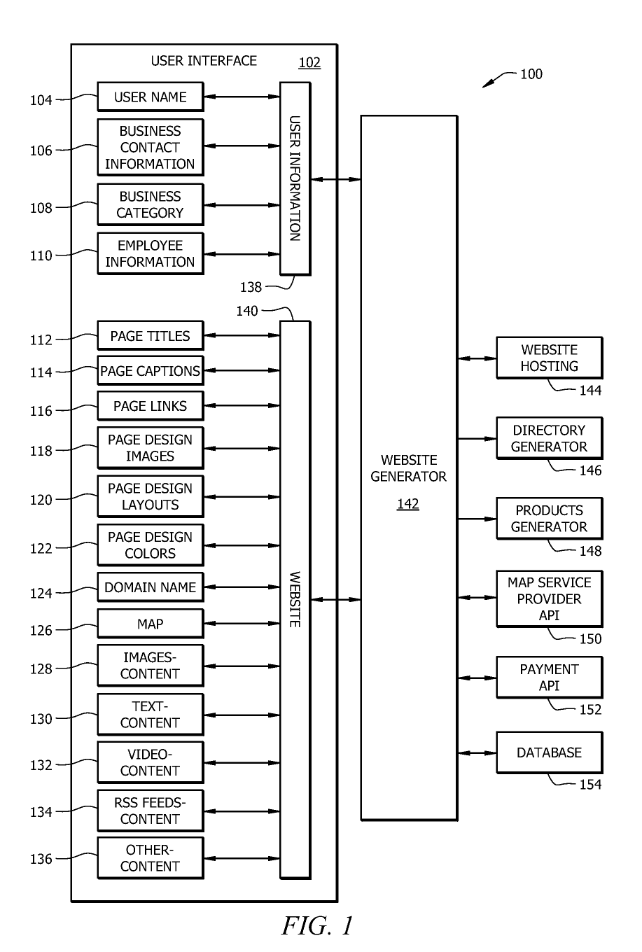

As shown in FIG. 1 an embodiment of the present invention 100 includes a user interface 102, website generator 142, website hosting service 144, directory generator 146, products generator 148, map service provider application programming interface 150, payment application programming interface 152, and database 154. Other embodiments of the present invention are envisioned having additional application programming interfaces such as without limitation a weather application programming interface.

A user interacts with an embodiment of the present invention via the user interface 102. Specifically, the user interacts with a system such as a particular machine, device, computer program or other complex tool. The user interface 102 provides means of input wherein the user is allowed to manipulate the system and also provides means of output wherein the system produces the effects of the user's manipulation. The user interface 102 preferably comprises a graphical user interface but may comprise any other user interface.

The user interface 102 comprising means for inputting, selecting, and displaying information and data to and from an embodiment of the present invention 100. Such means include without limitation a graphical, textual, and/or auditory apparatus and a control sequence such as but not limited to keystrokes with a computer keyboard, movements of a computer mouse, voice-activated commands, and/or selections with a touch screen.

The user interface 102 prompts the user to input a user name 104 and business contact information 106. Additionally the user may input employee information 110 and/or select a type of business category 108. The user interface 102 links to the website generator 142 which processes the user information 138 and creates a website 140.

The website 140 components include without limitation page titles 112, page captions 114, page links 116, page design images 118, page design layouts 120, page design colors 122, domain name 124, and map 126. Additionally the website 140 may include without limitation image-content 128, text-content 130, video-content 132, RSS feed-content 134, and other-content 136. Other content 136 may comprise audio content, non-RSS feed content, and/or fixed text content. Each aforementioned website component is specifically designed and created by the website generator 142 based upon the user information 138 supplied by the user. Furthermore each aforementioned component is instantly editable from the website 140 once it has been created by the website generator 142 without changing any other component or features of the website 140.

While the website generator 142 can generate the aforementioned components of the website 140 with minimum input by the user, to wit, a user name and business contact information 106, the user may pre-select any of the aforementioned components via the user interface 102 during the initial creation process of the website 140. The website generator 142 integrates the pre-selected components with the generated components to create the website 140.

Once the user information 138 and any pre-selected components are submitted to the website generator 142, the website 140 is instantly designed, created, hosted and publicized. The user does not input, select or purchase a domain name 124 because the website generator 142 creates and establishes a unique domain name 124 for the website 140 from the user information 138 submitted by the user.

The rights to the domain name 124 are acquired before the user interacts with an embodiment of the present invention. For example top-level and second-level domain names are acquired beforehand and are available for use during the creation and establishment of the website 140. The website generator 142 applies elements of the user information 138 to the already acquired top-level and second-level domain name to construct a unique domain name 124 to be associated with the website 140. For example business contact information 106 comprising the business' name and address including city, state or province, and country is utilized in conjunction with an already acquired top-level and second-level domain name to produce a unique multi-level domain name. As such the business name is assigned as a sub-domain to a domain name which includes the state or province, and country of the business' address. Thus for example, a domain name could be constructed by the website generator 142 as John-Smith-Attorney-Dallas.TX-npw.com.

The website generator 142 stores the user information 138 in the database 154 such as a MySQL database via a scripting language such as JavaScript and in HyperText Markup Language (HTML) form. From the data stored in the database 154, the website generator 142 constructs the domain name 124 and automatically confirms that the domain name 124 is unique and not a duplication of any other domain name utilized on the World Wide Web.

The website generator 142 designs and creates a website 140 having one or more web pages. Preferably the website generator 142 creates a website comprising a home page, profiles page, services page, facts page, photos page, contact page, map page, weather page, news page, and video page. An embodiment of the present invention is not limited or confined to only ten pages but may include more than or less than the preferred ten pages. Additional pages can be implemented and employed in various embodiments of the present invention.

Per the user information 138, the website generator 142 generates the components of the website 140 such as but not limited to the page titles 112, page captions 114, page links 116, page design images 118, page design layouts 120, page design colors 122, map 126, image-content 128, text-content 130, video-content 132, RSS feeds-content 134, and other-content 136. Once the aforementioned components are constructed by the website generator 142, the user may revise, change, edit, delete, or add to any of the components without adversely affecting any other components. The user's revisions, changes, edits, deletions, or additions are instantly visible online. As previously mentioned however, any of the aforementioned website components can be pre-selected by the user during the initial creation of the website 140 via the user interface 102. Components not pre-selected are automatically generated by the website generator 142.

The user need not understand any type of programming language such as HyperText Markup Language or secure the services of a website designer to design, create, or establish the website 140. Initially a user need only to enter the user information 130 to enable the website generator 142 to produce the website 140. After the creation of the website 140 by the website generator 142, the user can modify the website 140 by placing it in edit mode and by making the desired changes. In edit mode, the website 140 appears as it would in non-edit mode, thereby making the edit process easy and efficient.

As mentioned in the foregoing the website generator 142 generates at least one web page but preferably at least ten web pages. A page title 112 corresponds to each individual web page. The website generator 142 generates each web page, creates the page title 112 to be included thereon and/or highlights the page links 116 related to the page. For example the website generator 142 generates the facts page along with its associated content and additionally creates and displays “Facts” as the page title 112 and page link 116.

As mentioned in the foregoing, the website generator randomly constructs the page design images 118, page design layouts 120, and page design colors 122 if such components have not been pre-selected by the user during the initial creation of the website 140. In other embodiments the website generator 142 deciphers appropriate page design images 118, page design layouts 120, and page design colors 122 from the user information 138. For example user information 138 exhibiting a user's occupation as an attorney causes the website generator 142 to create page design images 118, page design layouts 120, and page design colors 122 having legal occupation characteristics. In this example the page design images 118 may comprise images of the scales of justice or law books, etc. Also the page design colors 122 and page design layout 120 may comprise respective colors and a layout commonly utilized for legal businesses.

A key aspect and significant advantage of the present invention is the random selection of the design and content, to wit, that every user receives a unique website with minimal effort. Having a database 154 of design elements and content elements, all of which are modular and interchangeable, promotes uniqueness with random selection from many possible combinations. All of the website components are modular, and this modularity provides uniqueness.

Once the website generator 142 has constructed the page design images 118, page design layouts 120, and page design colors 122 or once the user has pre-selected such components during the initial creation of the website 140, the user can revise, change, delete or add to the components when the website 140 is in edit mode. In edit mode, the user can select and retrieve other prepackaged images, layouts, and/or colors stored in the database 154. Additionally other embodiments are envisioned wherein the user is permitted to upload image(s) to the website 140. The uploaded image(s) are transmitted to the website generator 142 and are displayed on the website 140 in real time, thereby allowing a user to easily edit the website 140.

The database 154 comprises modified images for each design color and layout. Additionally the database 154 comprises information pertaining to various color schemes that aesthetically integrate with the modified images and layouts.

As mentioned in the foregoing, the website generator 142 generates the page captions 114 for the website 142 based in part upon the user name 104 and business contact information 106 provided by the user. Another embodiment provides the user with the ability to select business category information 108 via the user interface 102 during the initial creation of the website 140, thereby enhancing the page captions 114 as well as other components generated by the website generator 142. The page captions 114 comprise different captions dispersed on various web pages of the website 140. The page captions 114 include a title caption, description caption, motto caption, and welcome (or slogan) caption and preferably appear on every page of the website 140; however, other embodiments provide for captions that are dispersed among various web pages of the website 140. The website 140 can also include additional page captions 114 not described herein.

After the website generator 142 has constructed the page captions 114, the user may activate the edit mode on the website 114 and change, revise, delete or add to any constructed page caption 114. In edit mode the caption revisions are transmitted to the website generator 142 and are displayed on the website 140 in real time, thereby allowing a user to easily edit the website 140.

In page caption 114 construction the website generator 142 utilizes user information 138 in addition to stored information from the database 154. Specifically the title caption comprises the business name of the business contact information 106. As such the business name is displayed on the website 140 as the title caption. The welcome and motto captions, however, are generated by the website generator 142 utilizing information stored in the database 154. The database 154 includes data comprised of constructed words and/or phrases that characterize a welcome and motto caption which are randomly selected from the website generator 142 and displayed on the website 140. After the welcome and motto captions are randomly selected and displayed on the website 140, the user can modify, delete or add thereto by placing the website 140 in edit mode. Any modifications by the user to the welcome and/or motto captions are transmitted to the website generator 142 and displayed on the website 140 in real time, thereby allowing a user to easily edit the website 140.

The website generator 142 also constructs the description caption that is displayed on the website 140. The description caption may comprise generic or detailed information, depending upon which embodiment of the present invention is used. In one embodiment, the user does not provide business category information 108 and as such, the website generator 142 generates a generic description caption that is displayed on the website 140. However in another embodiment the user selects business category information 106 via the user interface 102 and as such the website generator 142 generates a detailed description caption that is displayed on the website 140.

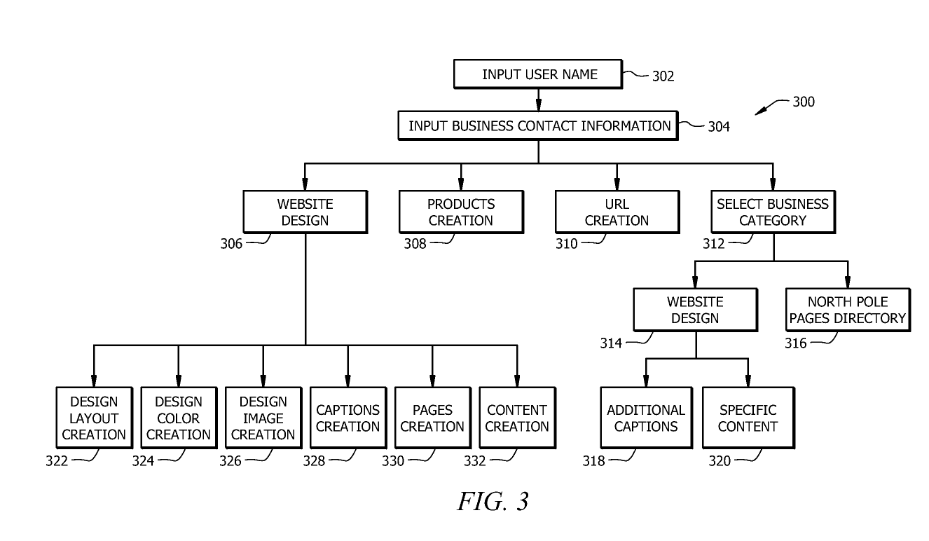

In the embodiment in which the user selects business category 108 information the user information 138 is enhanced with specifics of user's business type. In one embodiment the website generator 142 utilizes a unique system which quickly narrows down and hones in on the user's specific type of business. For example the user might select “legal” as business type from a wide array of business fields. Then the user is prompted to narrow the previous selection from a wide array of selections from the “legal” category; as such, the user might select “attorney.” Again the user is prompted to select a narrower occupational field; as such, the user might select “patent attorney.” In another embodiment the website generator 142 utilizes a unique keyword system to identify the user's specific type of business. The user enters a single keyword describing the user's business. Then the website generator 142 generates a comprehensive list of businesses associated with that keyword, including the various broad industries in which that business can occur. The user then selects his particular business and industry. The website generator 142 uses this information in the creation of various aspects of the website, including template selection and industry content. The website generator 142 also uses this information for the placement of the business in the director 316 (See FIG. 3).

The website generator 142 quickly narrows the selection of business categories 108 utilizing a unique system which provides the user with a quick, easy, and efficient method of business category 108 selections. If the user chooses not to provide any information regarding the business category 108, the website generator 142 generates generic information when constructing the description caption and other website content. If, however, the user provides business category 108 information, the website generator 142 generates detailed information when constructing the description caption and other website content. Therefore if a user selects a business occupation from the business category 108 selection prompt, the website generator 142 provides a detailed description caption and detailed website content to the website 140. The narrower the business category 108 selected by the user, the more detailed the description caption and other website content will become.

Embodiments are envisioned wherein unique drop-down menus or lists are employed during the selection process mentioned above. This type of selection process guarantees that the data entered by the user is exact as opposed to data gathered through text fields. The drop down menus or lists enable the website generator 142 not only to build better content but to create accurate and organized directory listings.

During the creation and construction of the website 140, the website generator 142 also may generate additional website content, specifically image-content 128, text-content 130, and video-content 132. In addition a web feed format such as without limitation a really simple syndication (hereinafter “RSS”) feed 134 or similar feed may be incorporated by the website generator 142 as content for the website 140.

If the user does not provide business category 108 information, the website generator 142 can generate generic image-content 128, text-content 130, and video-content 132 via the database 154 and/or RSS feeds-content 134 from the World Wide Web. For example, generic image-content 128 might be a picture of two business executives shaking hands, signifying an agreement. Generic text-content 130 might be text conveying the importance of customer service. Generic video-content 132 might be video exhibiting a news program via an RSS feed.

However if the user does provide business category 108 information, the website generator 142, based upon the type of occupation supplied by the user, can generate detailed image-content 128, text-content 130, and video-content 132 via the database 154. The website generator 142 matches the image-content 128, text-content 130, video-content, and RSS feed-content 134 with the type of occupation supplied to provide detailed content to the website 140. For example an occupational selection of a patent attorney may cause the website generator 142 to provide the website with a picture of a patent as image-content 128, text conveying a patent owner's right as text-content 132, news or other information concerning patent law as video-content 132 or similar RSS feed-content 134.

As with other website content created and constructed by the website generator 142, any image-content 130, video-content 132, and RSS feed-content can be changed, revised, deleted, or added to the website 140 without affecting other website content. Upon placing the website 140 in edit mode, the user can make any change which appears in real time. Also additional content including pictures and text can be uploaded to the website generator 142 and displayed in real time on the website 140 along with additional RSS feeds.

The website generator 142 may also select other content 136 for the website 140. For example, the website generator 142 may select music to be played during a viewing of the website 140. The website generator 142 randomly selects a musical piece from an array of musical performances related to the occupation, wherein such occupation is defined by the user information 138.

By linking to a map service provider's application programming interface 150, the website generator 142 utilizes the user's address entered by the user when entering the business contact information 106 to construct a map 126 of the location of the user's business address and incorporates the map 126 on the map page or any other page of the website 140. For example the website generator 142 can link to a map service provider application programming interface 150 such as Google™ Maps or Mapquest®, construct a map 126 of the user's address, and display the map 126 on the map page or any other page of the website 140.

As with other content created by the website generator 142, the map 126 can be modified by the user when the website 140 is in edit mode. If the user changes previously supplied business contact information 106 such as the user's address, the location of the business as depicted graphically by the map 126 also changes. Inputting new business contact information 106 causes the map 126 to graphically depict a new image of the newly supplied address in real time, thereby allowing the user to easily edit the website 140.

If the user chooses to enhance the user information 138 by providing business category 108 information, the website generator 142 links to a directory generator 146 which creates, constructs, and publishes a searchable directory. By utilizing the user information 138 entered during the initial creation of the website, the website generator 142 and directory generator 146 collectively streamline the website creation process, allowing the user to create a website and post to the directory in as few steps as possible. However, the user can add publishable information to the directory by providing business category 108 information at any time, even after the initial creation of the website 140.

By providing business category 108 information, the user assures that the website 140 not only receives publication in the directory via the directory generator 146 but also receives, as discussed above, more detailed website content specifically relating to the description caption of the page captions 114, image content 128, text content 130, video content 132, and RSS feeds-content 134. Therefore, providing the business category information 108 enhances the content of the website 140 while simultaneously providing publication in the directory.

The directory is searchable by users and non-users alike and comprises many searchable fields such as without limitation a business category field, business subcategory field(s), business form or type, business name and geographic location. As previously mentioned, the user may decide how narrowly to define the business category 108 information by only providing certain information. A search of the published directory is only as specific as the user information 138 supplied by the user. Therefore if a user provides only minimal business category 108 information, a search of the directory will not yield detailed results.

An embodiment of the present invention provides for a products generator 148 for creating uniquely identified stationery and/or other business supplies. During the initial creation of the website 140, the user enters user information 138 including the user name 104 and business contact information 106. The products generator 148 links to the website generator 142 and a database 154 whereupon the user information 138 is transferred to a printing press wherein the user information 138 such as but not limited to the business name, address, and telephone number(s) are printed to offices supplies wherein such office supplies comprise without limitation business cards, stationary, embossed pens, pencils, calendars, envelopes, coffee cups, mouse pads, sticky notes, T-shirts, souvenirs, and/or any other type of article.

The products generator 148 may be linked to an off-site printing press that produces uniquely labeled articles for delivery to the user at a later time. Because the products generator 148 links to the website generator 142 and the database 154, any changes to user information 138 result in immediate changes to information transmitted to the printing press. However in other embodiments, the user information 138 can be linked to the printing press via the World Wide Web and email. Additionally user information 138 can be linked to a PDF file builder comprised within the products generator 148, thereby providing local, on-site printing of stationery and other business accessories. Using the PDF file builder allows colors and images of the website 140 to be captured, displayed, and printed on the business accessories.

Once the website 140 is created, designed, and constructed, an embodiment of the present invention provides for immediate website hosting. As previously mentioned, the website generator 142 provides the website 140 its unique domain name 124 based upon the user information 138 supplied by the user. The website generator 142 links to a website hosting service 144, thereby providing continuous hosting.

Also an embodiment of the present invention provides for a secured transactional payment system wherein the user enters payment information via the user interface 102. The website generator 142 links to a payment application programming interface 152 which connects to a processing company such as a bank or credit card company.

During the creation of the website 140 and/or at any other time after creation, the user may be prompted or may elect via the user interface 102 to purchase certain services such as website hosting 144 or utilization of the products generator 148. If the user assents to the purchase agreement, a transaction is processed utilizing the payment application programming interface 152 which links to the website generator 142. In one embodiment, if the web hosting 144 is utilized, the web hosting 144 is automatically established upon completion of: the entering of the user information 138; the creation of the website 140; and the creation of the uniquely generated web address.

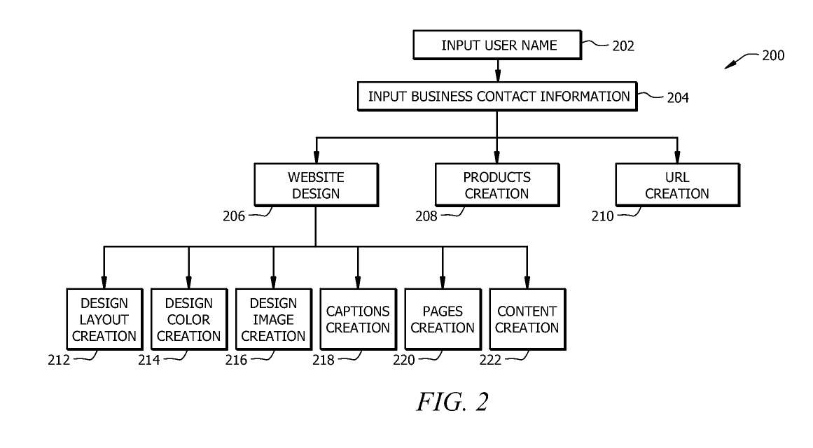

FIG. 2 illustrates another embodiment of the present invention comprising a method 200 for designing, creating, maintaining, editing and hosting a website with efficiency, speed, and ease wherein the user does not select business category information 108 during the initial creation of the website 140. The method 200 depicts the website creation, design, construction, establishment and hosting from the user's perspective.

When the user accesses the user interface 102 which links to an embodiment 200 of the present invention via an internet connection or other similar connection, the user is prompted to input a user name 202. The user name 202 can be a business trade name, personal name, alphanumeric phrase, or any other unique word, phrase, or symbol. Once the user inputs the user name 202, the user is prompted to input business contact information 204 which may include a physical address, email address, phone number, and/or other type of contact information.

After the user has entered the user name 202 and business contact information 204, a fully functioning accessible website is created and hosted with a unique uniform resource locator (hereinafter “URL”). The unique URL 210 is created, the website 206 is designed, and products 208 such as personalized stationary, business cards, embossed pens, or the like may be produced.

The website design creation process includes without limitation the creation of a design layout 212, design color 214, design image 216, captions 218, pages 220, and content 222. Upon creation of the website, the user can edit the website to include modification, revisions, deletions, or additions to any part of the website including content, URL address, user name, and/or business contact information. However any website creation component of the website design 206 can be pre-selected by the user during the initial creation of the website 140. The website creation components which are not pre-selected are generated by the website generator 142 and included in the website design 206.

The website design 206 of the embodiment 200 includes generalized RSS feed-content and captions. In this embodiment, the website and other related information are not posted to a searchable directory as is provided in the embodiment illustrated in FIG. 3.

FIG. 3 illustrates yet another embodiment of the present invention comprising a method 300 for creating, designing, constructing, establishing and hosting a website wherein the user selects business category information 108 during the initial creation of the website 140. As such the website 140 comprises detailed website content and detailed website captions and posts to a searchable directory. The method 300 depicts the website creation, design, construction, establishment and hosting from the user's perspective.

When the user accesses the user interface 102 which links to an embodiment 300 of the present invention via an internet connection or other similar connection, the user is prompted to input a user name 302. The user name 302 can be a business trade name, personal name, alphanumeric phrase, or any other unique word, phrase, or symbol. Once the user inputs the user name 302, the user is prompted to input business contact information 304 which may include a physical address, email address, phone number, and/or other type of contact information.

After the user has entered the user name 302 and business contact information 304, a fully functioning accessible website is created and hosted with a unique URL. The unique URL 310 is created and products 308 such as personalized stationary, business cards, embossed pens, or the like may be produced without supplying other information.

The user is then prompted to select a business category 312 wherein the user in a step-by-step fashion progressively selects detailed business category 312 information via the selection of subcategories or a key word list until the selection process is exhausted or the user terminates the selection process. Providing business category 312 information enhances the website by providing more detailed website design 314, 306 and enables the posting of the website and/or other user information to a searchable directory 316. The directory 316 can be searched using the business category, business subcategories, business name, business description, or business geographical location such as city, state, country or zip code.

The website design creation process 306, 314 includes without limitation the creation of a design layout 322, design color 324, design image 326, captions 328, pages 330, content 332, additional captions 318, and specific content 320. Because of the selection of the business category 312, the website design 306, 314 includes more detailed content. Detailed content includes detailed RSS feeds or other specific content 320 as well as additional captions 318 such as the description caption. Based upon the business category 312 information provided by the user, the website design 306, 314 is more closely contoured to the user's business, providing detailed information to website visitors who view content therefrom. However, as in the previous embodiment of FIG. 2, any website creation component of the website design 306 can be pre-selected by the user during the initial creation of the website 140. The website creation components which are not pre-selected by the user are generated by the website generator 142 and included in the website design 306,314.

The method and system of the present invention applies to user interfaces, regardless of type or content, databases, regardless of type or content, directory generators, regardless of type, products generator, regardless of type, websites, regardless of type, content or use, website design, regardless of how the website is designed, and website hosting, regardless of how, when, or where the hosting is performed.

Although preferred embodiments of the invention have been illustrated in the accompanying Drawings and described in the foregoing Detailed Description, it will be understood that the invention is not limited to the embodiments disclosed, but is capable of numerous rearrangements, modifications, and substitutions of parts and elements without departing from the spirit of the invention.

What is claimed is:

1. A machine-implemented method of creating and managing a website comprising:
receiving information from a user, the information selected from the group consisting of business information and personal information;
responsive to receiving the information from the user, automatically creating a website using a website generator, the website derived at least in part from the received information;
providing a website generator;
responsive to receiving the information from the user, automatically creating a unique domain name using the website generator, the domain name derived at least in part from the received information; and
responsive to the creation of the website and further responsive to the creation of the unique domain name, automatically communicating the created website and domain name to a website hosting service for facilitating the hosting of the created website.

2. The method of claim 1, further comprising:
receiving information corresponding to pre-selected components from the user;
responsive to receiving the information corresponding to the pre-selected components, automatically creating the website using the website generator, the website derived at least in part from each of the information corresponding to the pre-selected components and the information selected from the group consisting of business information and personal information.

3. The method of claim 1, further comprising:
responsive to the creation of the domain name, automatically confirming the uniqueness of the created domain name.

4. The method of claim 1, wherein the automatic creation of the website includes randomly selecting at least a portion of the design and content of the created website from a database containing a plurality of design elements and a plurality of content elements.

5. The method of claim 1, further comprising:
receiving an edit request from a user to edit the created website;
responsive to the received edit request, automatically completing a function selected from the group consisting of revising, changing, deleting and adding information to the created website.

6. The method of claim 1, and further comprising:
responsive to the created website, creating products based at least in part on the information utilized to create the website.

7. The method of claim 1, and further comprising:
responsive to the creation of the website and further in response to the creation of the unique domain name, automatically communicating information related to the created website and created domain name to a directory generator;
responsive to receiving the information related to the created website and created domain name, creating and publishing a searchable directory corresponding to created website and domain name.
